(19) United States
(12) Patent Application Publication
(10) Pub. No.: US 2014/0303955 A1
(43) Pub. Date: Oct. 9, 2014

(54) APPARATUS AND METHOD FOR RECOGNIZING AN IDIOMATIC EXPRESSION USING PHRASE ALIGNMENT OF A PARALLEL CORPUS

(71) Applicants: Sang-Bum Kim, Seoul (KR); Chang Hao Yin, Seoul (KR); Young Sook Hwang, Seoul (KR); Hae Chang Rim, Seoul (KR); Hyoung Gyu Lee, Seoul (KR)

(72) Inventors: Sang-Bum Kim, Seoul (KR); Chang Hao Yin, Seoul (KR); Young Sook Hwang, Seoul (KR); Hae Chang Rim, Seoul (KR); Hyoung Gyu Lee, Seoul (KR)

(73) Assignee: SK PLANET CO., LTD., Seoul (KR)

(21) Appl. No.: 13/820,199

(22) PCT Filed: May 25, 2011
(86) PCT No.: PCT/KR2011/003832

§ 371 Date: Mar. 11, 2013

(30) Foreign Application Priority Data
Sep. 2, 2010 (KR) 10-2010-0085959

(51) Int. Cl. G06F 17/28

(52) U.S. Cl. CPC G06F 17/289
USPC 704/2

(57) ABSTRACT

The present disclosure relates to an apparatus and a method for recognizing an idiomatic expression using phrase alignment of a bilingual parallel corpus, and more particularly, to an apparatus and a method for recognizing an idiomatic expression using phrase alignment of a parallel corpus which extract a candidate idiomatic expression using phrase alignment information of a bilingual parallel corpus and measure an idiomatic expression index for every extracted candidate idiomatic expression to recognize the candidate idiomatic expression as an idiomatic expression to resolve errors in measuring a translational entropy of a word and extracting a representative translated word of the word and improve the accuracy of the idiomatic expression recognition.

### TECHNICAL FIELD

The present disclosure relates to an apparatus and a method that recognize an idiomatic expression using phrase alignment of a bilingual parallel corpus, and more particularly, to an apparatus and a method for recognizing an idiomatic expression using phrase alignment of a parallel corpus which extract a candidate idiomatic expression using phrase alignment information of a bilingual parallel corpus and measure an idiomatic expression index for every extracted candidate idiomatic expression to recognize the candidate idiomatic expression as an idiomatic expression to resolve errors in measuring a translational entropy of a word and extracting a representative translated word of the word and improve the accuracy of the idiomatic expression recognition.

### BACKGROUND ART

An automatic translation technology refers to a software technology that automatically converts one language into another language. The technology has been studied since the mid 20th century in the United States for a military purpose and is still being actively studied for the purposes of expanding an information access range to a global wide and innovating of a human interface in various research institutes and private enterprises now.

At the initial stage, the automatic translation technology has been developed based on a bilingual dictionary that is manually prepared by professionals and rules that convert one language into another language. However, from the early 21th century when a computing power is rapidly developed, a technology that automatically and statistically learns a translation algorithm from a large amount of data is actively developed.

A related art that recognizes an idiomatic expression from a bilingual parallel corpus measures translational entropy of individual words of the expression or a rate of default translation when one expression or a word string is given. The measured value is used to make a ranking of candidate expressions to obtain top ranked expressions as idiomatic expressions. The above-mentioned related art proves that when the word alignment is used in the bilingual parallel corpus, it is useful to recognize the idiomatic expression. The idiomatic expression was obtained with a high accuracy when a phrase to which a linguistic constraint is applied is used as a candidate. However, the above related art has some limitations to obtain various idiomatic expressions.

First, the candidate idiomatic expressions in the related art are limited to patterns to which the linguistic constraint is applied so that only a very small amount of idiomatic expressions are obtained even though there are many idiomatic expressions with various patterns in the corpus. For example, a verb phrase consisting of a combination of a verb and a prepositional phrase may be included in many idiomatic expressions with various patterns. If the related art simply expands to all available N-grams, any noises may be included to be extracted. Therefore, in order to obtain various idiomatic expressions, it is required to extract an N-gram unit which is meaningful but not linguistically constrained.

Second, the related art considers translation in the unit of word, but not translation in the unit of phrase. Therefore, the accuracy of recognizing the idiomatic expression is limited. Further, since the difference between the translation tendency of individual words and the translation tendency when the individual words are tied as a phrase is not precisely analyzed using the phrase alignment, the accuracy of the idiomatic expression recognition is lowered.

The idiomatic recognition technology of the related art uses word alignment information in order to measure the translational entropy of words that configures the phrase or understand meanings through a representative translated word. An idiomatic expression recognizing method of the related art mainly uses word alignment information in order to recognize the idiomatic expression from the bilingual parallel corpus. In order to determine whether a given expression is an idiomatic expression, the translational entropy of the words is measured using a word alignment statistics of the bilingual parallel corpus or a final score is calculated after selecting a default translated word of the word. The related art that obtains the default translated word and the translational entropy only though the word alignment is significant only for word to word (1:1) translation but when one word is translated into several words (1:n), wrong default translated word is selected or the accuracy of translational entropy is lowered. In other words, the idiomatic recognition technology of the related art has errors in measuring the translational entropy of a word and extracting a representative translated word of the word.

### DISCLOSURE

### Technical Problem

Accordingly, the present disclosure has been made in an effort to provide an apparatus and a method for recognizing an idiomatic expression using phrase alignment of a bilingual parallel corpus which extract a candidate idiomatic expression using phrase alignment information of a bilingual parallel corpus and measure an idiomatic expression index for every extracted candidate idiomatic expression to recognized the candidate idiomatic expression as an idiomatic expression to resolve errors in measuring a translational entropy of a word and extracting a representative translated word of the word and improve the accuracy of the idiomatic expression recognition.

### Technical Solution

In order to achieve the above object of the present disclosure, an apparatus according to a first aspect of the disclosure includes: a bilingual parallel corpus input unit that receives a bilingual parallel corpus; a phrase aligning unit that performs phrase alignment for every sentence pair of the input bilingual parallel corpus; a candidate expression extracting unit that extracts a candidate idiomatic expression using the performed phrase alignment result; and an idiomatic expression recognizing unit that measures an idiomatic expression index for every extracted candidate idiomatic expression and compares the measured idiomatic expression index with a predetermined threshold to recognize the extracted candidate idiomatic expression as an idiomatic expression.

Preferably, the phrase aligning unit connects a source phrase with a target phrase in the bilingual parallel sentence pair of the input bilingual parallel corpus to perform the phrase alignment.

Preferably, the phrase aligning unit performs the phrase alignment including word alignments of word to word, one word to several words, and several words to several words for every sentence pair of the input bilingual parallel corpus.

Preferably, the candidate expression extracting unit extracts the candidate idiomatic expression from the phrase pairs in which the phrases are aligned using a source portion phrase as one basic unit.

Preferably, the candidate expression extracting unit removes a phrase including at least one of a period, a comma, quotation marks, and parentheses or removes a phrase having only one word excepting articles and prepositions from the extracted candidate idiomatic expression.

Preferably, the idiomatic expression recognizing unit calculates an idiomatic expression index of the extracted candidate idiomatic expression using a translational entropy function to recognize an idiomatic expression.

Preferably, the idiomatic expression recognizing unit compares words in a default phrase translation obtained from the performed phrase alignment result with words in a default phrase translation of words in a phrase to calculate an overlapping percentage to recognize the idiomatic expression.

A method according to a second aspect of the disclosure includes a bilingual parallel corpus input step of receiving a bilingual parallel corpus; a phrase aligning step of performing phrase alignment for every sentence pair of the input bilingual parallel corpus; a candidate expression extracting step of extracting a candidate idiomatic expression using the performed phrase alignment result; and an idiomatic expression recognizing step of measuring an idiomatic expression index for every extracted candidate idiomatic expression and comparing the measured idiomatic expression index with a predetermined threshold to recognize the extracted candidate idiomatic expression as an idiomatic expression.

Preferably, the phrase aligning step connects a source phrase with a target phrase in the bilingual parallel sentence pair of the input bilingual parallel corpus to perform the phrase alignment.

Preferably, the phrase aligning step performs the phrase alignment including word alignments of word to word, one word to several words, and several words to several words for every sentence pair of the input bilingual parallel corpus.

Preferably, the candidate expression extracting step extracts the candidate idiomatic expression from the phrase pairs in which the phrases are aligned using a source portion phrase as one basic unit.

Preferably, the candidate expression extracting step removes a phrase including at least one of a period, a comma, quotation marks, and parentheses or removes a phrase having only one word excepting articles and prepositions from the extracted candidate idiomatic expression.

Preferably, the idiomatic expression recognizing step calculates an idiomatic expression index of the extracted candidate idiomatic expression using a translational entropy function to recognize an idiomatic expression.

Preferably, the idiomatic expression recognizing step compares words in a default phrase translation obtained from the performed phrase alignment result with words in a default phrase translation of words in a phrase to calculate an overlapping percentage to recognize the idiomatic expression.

### Advantageous Effects

According to the present disclosure, it is possible to resolve the errors in measuring the translational entropy of a word and extracting a representative translated word of the word using the phrase alignment information in order to recognize an idiomatic expression using a bilingual parallel corpus.

Further, the present disclosure extracts the translational entropy of a phrase and a representative translated word of the phrase to more precisely recognize the idiomatic expression while focusing on an entropy change and the translated word change from a word into a phrase. Further, the present disclosure uses the phrase alignment statistics of the bilingual parallel corpus to obtain the translational entropy and a default translated word in the unit of phrase, which allows the automatic idiom recognition with a higher accuracy.

Furthermore, the present disclosure improves the accuracy of the idiomatic expression recognition. As an experimental result for the accuracy of the idiomatic expression recognition according to the present disclosure, an average accuracy is improved by 36.2% as compared with the related art that uses the word alignment in the idiomatic expression recognition of English using an English-Korea parallel corpus.

The present disclosure may recognize more various idiomatic expressions. As an experimental result for the number of idiomatic expression recognition according to the present disclosure, 50,000 or more idiomatic expressions may be recognized from approximately 500,000 sentence pairs of corpora with a reliable accuracy (for example, 71%).

### DESCRIPTION OF DRAWINGS

FIG. 1 is a configuration diagram of an exemplary embodiment for an idiom recognizing apparatus using phrase alignment information of a bilingual parallel corpus according to the present disclosure.

FIG. 2 is an exemplary diagram of an exemplary embodiment for phrase alignment that is performed by a phrase aligning unit of FIG. 1 according to the present disclosure.

FIG. 3 is a flowchart of an exemplary embodiment for an idiom recognizing method using phrase alignment information of a bilingual parallel corpus according to the present disclosure.

### DESCRIPTION OF MAIN REFERENCE NUMERALS OF DRAWINGS

100: Idiomatic expression recognizing apparatus

110: Bilingual parallel corpus input unit

120: Phrase aligning unit

130: Candidate expression extracting unit

140: Idiomatic expression recognizing unit

### BEST MODE

Hereinafter, exemplary embodiments of the present disclosure will be described in detail with reference to accompanying drawings. Configurations and effects thereof will be apparently understood through the following detailed description. In the figures, the same reference numbers refer to the same or equivalent parts of the present disclosure throughout the several figures of the drawing. However, if it is considered that description of related known configuration or function may make the gist of the present disclosure unclear, the description will be omitted.

In order to solve the problems of the related art that obtains only a very small amount of idiomatic expressions by applying a linguistic constraint, the present disclosure extracts a meaningful n-gram unit so as to obtain various idiomatic expressions. The present disclosure extracts a meaningful n-gram unit to extract a candidate idiomatic expression and recognizes an idiomatic expression among candidates by recognizing the idiomatic expression while considering translation in the unit of phrase.

Further, in order to solve the problems of the related art that does not consider the translation in the unit of phrase so that the translation tendency of the idiomatic expression is not analyzed, the present disclosure provides an apparatus and a method for recognizing an idiomatic expression that considers the translation in the unit of phrase based on the phrase alignment.

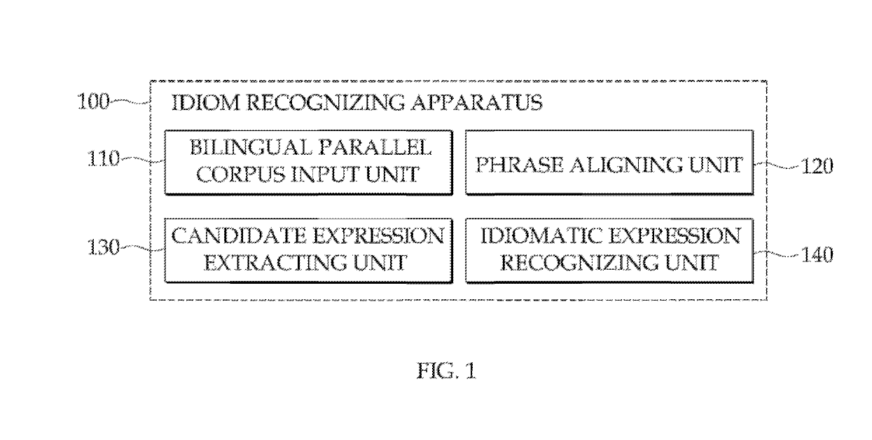

FIG. 1 is a configuration diagram of an exemplary embodiment for an idiom recognizing apparatus using phrase alignment information of a bilingual parallel corpus according to the present disclosure.

As shown in FIG. 1, an idiomatic expression recognizing apparatus 100 using phrase alignment information of a bilingual parallel corpus according to the present disclosure includes a bilingual parallel corpus input unit 110, a phrase aligning unit 120, a candidate expression extracting unit 130, and an idiomatic expression recognizing unit 140.

Hereinafter, individual components of the idiomatic expression recognizing apparatus 100 according to the present disclosure will be described.

The bilingual parallel corpus input unit 110 receives a bilingual parallel corpus. Here, the bilingual parallel corpus consists of a source language sentence and a target language translated sentence corresponding thereto.

The phrase aligning unit 120 performs phrase alignment for every sentence pair of the bilingual parallel corpus input from the bilingual parallel corpus input unit 110. The phrase aligning unit 120 extracts not only an attribute in the unit of word but also an attribute in the unit of phrase in the bilingual parallel corpus in order to recognize the idiomatic expression. In other words, the phrase aligning unit 120 obtains a phrase alignment result in the bilingual parallel corpus.

Here, the phrase alignment allows a chunk which is a chunk of meaningful words to be extracted and provides a useful statistics which will be used to analyze a translation tendency of the phrase. The phrase alignment is studied in the field of a statistical machine translation. The phrase alignment connects a source phrase of the source sentence in a given one pair of bilingual parallel sentences with a target phrase which is considered as the translation thereof.

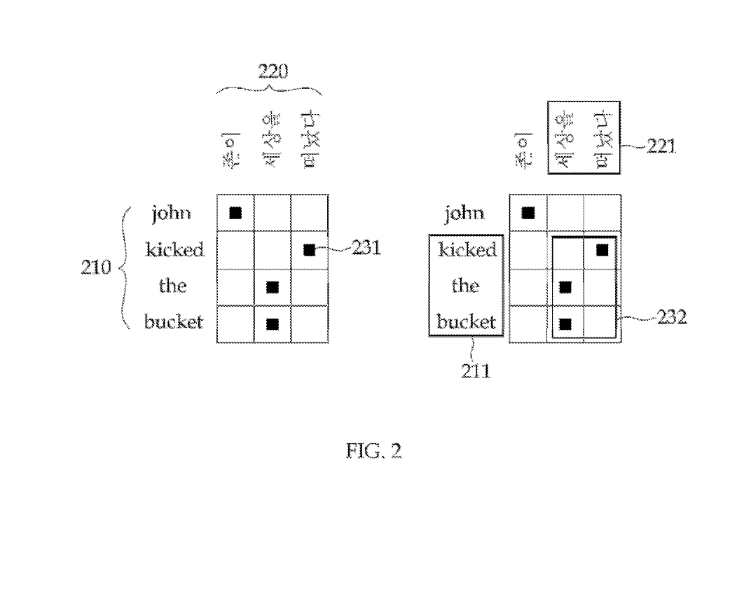

FIG. 2 is an exemplary diagram of an exemplary embodiment for phrase alignment that is performed by the phrase aligning unit 120 of FIG. 1 according to the present disclosure.

As shown in FIG. 2, the phrase aligning unit 120 receives a bilingual parallel corpus including a source sentence, “john kicked the bucket” 210 and “ . . . ” 220, from the bilingual parallel corpus input unit 110. Here, a black rectangle 231 indicates a word alignment result in the bilingual parallel corpus.

The phrase aligning unit 120 recognizes “kicked the bucket” 211 and “ . . . ” 221 as one phrase to perform a phrase alignment 232. The phrase aligning unit 120 performs the phrase alignment through various phrase aligning methods. The phrase aligning unit 120 obtains any one phrase alignment result among word to word (1:1) alignment, word to several words (1:n) alignment, and several words to several words (n:m) alignment.

In the meantime, the candidate expression extracting unit 130 extracts candidate idiomatic expressions using the phrase alignment result performed in the phrase aligning unit 120. The candidate expression extracting unit 130 may extract an idiomatic expression (for example, a noun phrase idiom, a verb phrase idiom, and a prepositional phrase idiom) expressed by various patterns while reducing a complexity. The candidate expression extracting unit 130 recognizes a meaningful chunk using the phrase alignment result performed in the phrase aligning unit 120 to extract the candidate idiomatic expression. The candidate expression extracting unit 130 extracts a candidate idiomatic expression from the phrase pairs in which the phrases are aligned using a source portion phrase as one basic unit. The candidate expression extracting unit 130 applies several simple rules to all candidate phrases extracted as described above to perform filtering.

The candidate expression extracting unit 130 may filter all candidate phrases in accordance with a first filtering rule that removes a phrase including at least one of a period, a comma, quotation marks, and parentheses. Further, the candidate expression extracting unit 130 may filter all candidate phrases in accordance with a second filtering rule that removes a phrase having only one word excepting articles and prepositions. The candidate expression extracting unit 130 may significantly reduce the number of candidate idiomatical expressions through the first and second filtering rules to increase the efficiency of the idiom recognizing apparatus.

The idiomatic expression recognizing unit 140 measures an idiomatic expression index for every candidate idiomatic expression extracted from the candidate expression extracting unit 130 and compares the measured idiomatic expression index with a predetermined threshold to recognize the idiomatic expression. In other words, the idiomatic expression recognizing unit 140 measures the idiomatic expression index for every candidate idiomatic expression to make a ranking indicating how close to an idiomatic expression. Continuously, the idiomatic expression recognizing unit 140 compares the measured idiomatic expression index with the predetermined threshold to recognize the idiomatic expression.

Specifically, the idiomatic expression recognizing unit 140 applies the idiomatic expression index to every candidate expression. Here, when a higher idiomatic expression index is given to a candidate idiomatic expression, the candidate idiomatic expression may be relatively an idiomatic expression. In contrast, when a lower idiomatic expression index is given to a candidate idiomatic expression, the candidate idiomatic expression may be a relatively general expression rather than an idiom.

The idiomatic expression recognizing unit 140 uses two idiomatic expression index functions based on the phrase alignment result to apply the idiom expression index to every candidate expression.

First, an idiomatic expression index function (hereinafter, referred to as a “first idiomatic expression index function”) for a decrement of translational entropy (DTE) will be described.

The individual words in the idiomatic expression may be translated into various words. However, a first idiomatic expression index function is an idiomatic expression index function having an assumption that a phrase may be translated into several fixed expressions when individual words are tied as one phrase. For example, in “lie down”, the word “lie” and the word “down” have various translated words. However, “lie down” tends to be restrictively translated into “ . . . ” or “ . . . ”. The following [Equation 1] represents the first idiomatic expression index function (DTE(p)) that reflects the translation tendency described above.

$$D T E ( p ) = \frac{1}{2} ( \frac{{\sum }_{w ∈ {W}_{p}} H ( {T}_{w} \vert ω )}{\vert {W}_{p} \vert} - H ( {T}_{p} \vert p ) ) + 0.5 \qquad [ Equation 1 ]$$

Here, DTE (p) indicates the first idiomatic expression index function, Wₚ indicates a set of words in one phrase p, Tₚ indicates a set of target phrases aligned as a phrase p, and H(Tₚ|p) indicates a translational entropy of the phrase p calculated by the following [Equation 2] and [Equation 3].

$$\begin{matrix}H ( {T}_{p} \vert p ) = - {\sum }_{t ∈ {T}_{p}} P ( t \vert p ) log P ( t \vert p ) & [ Equation 2 ] \\ P ( t \vert p ) = \frac{count ( t , p )}{{\sum }_{t} count ( t , p )} & [ Equation 3 ]\end{matrix}$$

Here, P(t|p) indicates a probability that the source phrase p is translated into a target phrase (t) and a count (t,p) indicates the number of source phrases (p) and target phrases (t) which are put together.

An example that calculates the decrement of translational entropy using the first idiomatic expression index function (DTE(p) will be described with reference to the following Table 1.

TABLE 1

| Candidate | |
|---|---|
| Phrase | Calculation Procedure |
| tv drama | H(Tₜᵥ\|tv) = 0.28 |
| | H(T_{drama}\|drama) = 0.48 |
| | H(T_{tv drama}\|tv drama) = 0.73 |
| | DT E(tv drama) = |
| | $\frac{1}{2} ( \frac{0.28 + 0.48}{2} - 0.73 ) + 0.5 = 0.32$ |
| new york | H(T_{new}\|new) = 0.72 |
| | H(T_{york}\|york) = 0.54 |
| | H(T_{new york}\|new york) = 0.19 |
| | DT E(new york) = |
| | $\frac{1}{2} ( \frac{0.72 + 0.54}{2} - 0.19 ) + 0.5 = 0.72$ |

As represented in Table 1, when the candidate phrases are “tv drama” and “new york”, the calculation procedure of the first idiomatic expression index function for the candidate phrases will be described.

First, in case of “tv drama”, the first idiomatic expression index function (DTE (tv drama) is calculated as “0.32”.

Second, in case of “new york”, the first idiomatic expression index function (DTE (new york) is calculated as “0.72”.

As a value of the first idiomatic expression index function is lower, the probability that the candidate idiomatic expression is recognized as an idiomatic expression is increased. In contrast, as the value of the first idiomatic expression index function is higher, the probability that the candidate idiomatic expressions is recognized as an idiomatic expression is decreased.

Second, the difference of translated words (DTW) (hereinafter, referred to as a “second idiomatic expression index function”) will be described.

The difference of the translated words which is the second idiomatic expression index function (DTW) uses a default phrase translation which may be obtained from the phrase alignment. The default phrase translation refers to an N-best translation of one source phrase. Here, the N-best translation refers to a most frequently translated phrase translation. The second idiomatic expression index function contains an assumption that vocabulary difference between the default phrase translation of individual words of the idiomatic expression and the default phrase translation of the expression itself is significant, which means that the words translated into the idiomatic expression are significantly different from each other. The second idiomatic expression index function that indicates the difference of the translated words is represented by the following Equation 4.

$$D T W ( p ) = 1 - \frac{\vert tokens ( {D}_{p} ) ⋂ {⋃}_{w ∈ {W}_{p}} tokens ( {D}_{w} ) \vert}{\vert tokens ( {D}_{p} ) \vert} \qquad [ Equation 4 ]$$

Here, Dₚ indicates a default phrase translation of a phrase p, that is, a set of N-best translations of the phrase p and D_{w} indicates the N-best translations of a word w. ‘tokens ( )’ indicates a function that outputs a set of all words obtained from elements when a set of phrases is given and is expressed by the following [Equation 5].

$$tokens ( {D}_{p} ) = {⋃}_{d ∈ {D}_{p}} {W}_{d} \qquad [ Equation 5 ]$$

Here, Dₚ indicates an N-best translations of a phrase p.

An example that calculates the difference of translated words using the second idiomatic expression index function (DTW(p)) will be described with reference to the following [Table 2].

TABLE 2

| Candidate | |
|---|---|
| Phrase | Calculation Procedure |
| tv drama | Dₜᵥ = {tv, tellebijeon} |
| | D_{drama} = {deurama, sageuk} |
| | D_{tv drama} = {deurama, tv deurama} |
| | DTW(tv drama) = |
| | $1 - \frac{3}{3} = 0.00$ |
| takechargeof | Dₜₐₖₑ = {chwihada, hada} |
| | D_{charge} = {hyeomeui, go it} |
| | D_{of} = {eui, e daehan} |
| | D_{take charge of} = {reul mat, mat} |
| | DTW(take charge of) = |
| | $1 - \frac{0}{3} = 1.00$ |

As represented in [Table 2], when candidate phrases are “tv drama” and “takechangeof”, a calculation procedure of the second idiomatic expression index function for the candidate phrases (candidate procedure) will be described.

First, in case of “tv drama”, the second idiomatic expression index function (DTW(tv drama)) is calculated as “0.00”.

Second, in case of “takechangeof”, the second idiomatic expression index function (DTW(takechangeof)) is calculated as “1.00”.

As a value of the second idiomatic expression index function is higher, the probability that the candidate idiomatic expression is recognized as an idiomatic expression is increased. In contrast, as the value of the second idiomatic expression index function is lower, the probability that the candidate idiomatic expression is recognized as an idiomatic expression is decreased.

The second idiomatic expression index function DTW compares words in the default phrase translation of the phrase p with words in the default phrase translation of words of the phrase p to calculate an overlapping percentage. Here, as the words in the default phrase translation less overlap the words in the default phrase translation of words, it is recognized as an idiomatic expression. In contrast, as the words in the default phrase translation more overlap the words in the default phrase translation of words, it is not recognized as an idiomatic expression. The second idiomatic expression index function (DTW) subtracts the percentage from 1 in order to allocate a large value to the idiomatic expression. The second idiomatic expression index function may directly extract the default phrase translation of the candidate phrase itself using the phrase alignment to reflect the translation procedure at a phase level to the idiomatic expression recognition.

A combined idiomatic expression index function linearly combines the first and second idiomatic expression index functions (DTE and DTW) to be represented as the following [Equation 6].

Score(p)=λDTE(p)+(1−λ)DTW(p) [Equation 6]

Here, Score(p) indicates a value of a combined idiomatic expression index function of the phrase p, DTE(p) indicates the first idiomatic expression index function, DTW(p) indicates the second idiomatic expression index function, and λ, indicates a constant value of the idiomatic expression index function.

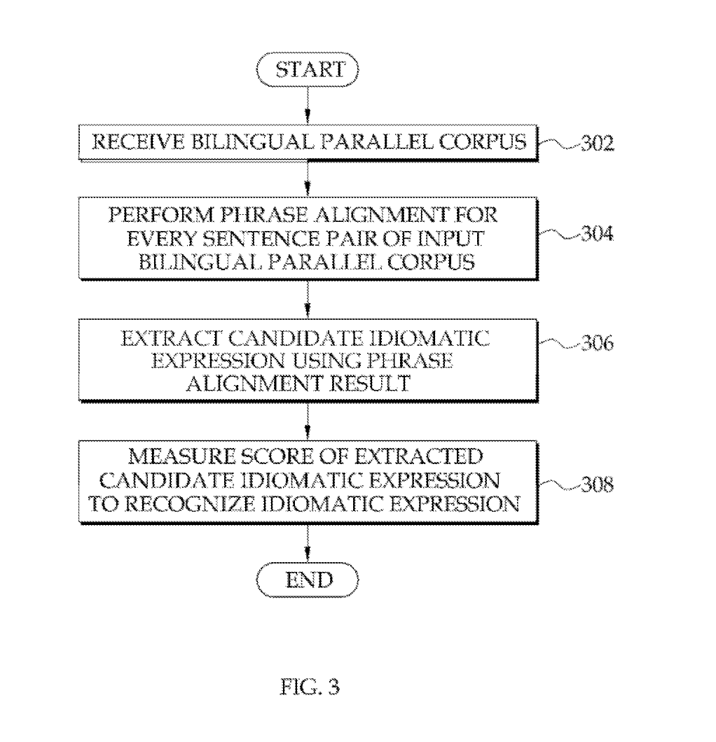

FIG. 3 is a flowchart of an exemplary embodiment for an idiom recognizing method using phrase alignment information of a bilingual parallel corpus according to the present disclosure.

The bilingual parallel corpus input unit 110 receives a bilingual parallel corpus (302).

The phrase aligning unit 120 performs phrase alignment for every sentence pair of the bilingual parallel corpus input from the bilingual parallel corpus input unit 110 (304). The phrase aligning unit 120 extracts not only an attribute in the unit of word but also an attribute in the unit of phrase in the bilingual parallel corpus in order to recognize the idiomatic expression. The phrase aligning unit 120 obtains a phrase alignment result in the bilingual parallel corpus.

In the meantime, the candidate expression extracting unit 130 extracts candidate idiomatic expressions using the phrase alignment result performed in the phrase aligning unit 120 (306). The candidate expression extracting unit 130 may extract an idiomatic expression (for example, a noun phrase idiom, a verb phrase idiom, and a prepositional phrase idiom) expressed by various patterns while reducing a complexity. The candidate expression extracting unit 130 recognizes a meaningful chunk using the phrase alignment result performed in the phrase aligning unit 120 to extract the candidate idiomatic expression. The candidate expression extracting unit 130 extracts a candidate idiomatic expression from the phrase pairs in which the phrases are aligned using a source portion phrase as one basic unit. The candidate expression extracting unit 130 applies several simple rules to all candidate phrases extracted as described above to perform filtering.

The candidate expression extracting unit 130 may filter all candidate phrases in accordance with a first filtering rule that removes a phrase including at least one of a period, a comma, quotation marks, and parentheses. Further, the candidate expression extracting unit 130 may filter all candidate phrases in accordance with a second filtering rule that removes a phrase having only one word excepting articles and prepositions. The candidate expression extracting unit 130 may significantly reduce the number of candidate idiomatical expressions through the first and second filtering rules to increase the efficiency of the idiom recognizing apparatus.

The idiomatic expression recognizing unit 140 measures the idiomatic expression index for every candidate idiomatic expression extracted from the candidate expression extracting unit 130 to make a ranking indicating how close to an idiomatic expression (308). The idiomatic expression recognizing unit 140 compares the measured idiomatic expression index with the predetermined threshold to recognize the idiomatic expression.

Specifically, the idiomatic expression recognizing unit 140 applies the idiomatic expression index to every candidate expression. Here, when a higher idiomatic expression index is given to a candidate idiomatic expression, the candidate idiomatic expression may be relatively an idiomatic expression. In contrast, when a lower idiomatic expression index is given to a candidate idiomatic expression, the candidate idiomatic expression may be a relatively general expression rather than an idiom. The idiomatic expression recognizing unit 140 uses two idiomatic expression index functions based on the phrase alignment result to apply a value of the idiom expression index function to every candidate expression.

In the meantime, the present disclosure may implement the above-described idiomatic expression recognizing method using the phrase alignment of the bilingual parallel corpus as a software program and record the method in a predetermined computer readable recording medium to be applied to various reproducing devices.

The various reproducing devices may be a PC, a notebook computer, or a portable terminal.

For example, the recording medium may be a hard disk, a flash memory, a RAM, or a ROM which is installed in the reproducing device or an optical disk such as a CD-R, a CD-RW, a compact flash card, a smart media, a memory stick, or a multimedia card which is externally installed.

In this case, as described above, the program that is recorded in a computer readable recording medium may be performed so as to include a bilingual parallel corpus input function that receives a bilingual parallel corpus; a phrase aligning function that performs the phrase alignment for every sentence pair of the input bilingual parallel corpus; a candidate expression extracting function that extracts the candidate idiomatic expression using the performed phrase alignment result; and an idiomatic expression recognizing function that measures the idiomatic expression index for every extracted candidate idiomatic expression and compares the measured idiomatic expression index with a predetermined threshold to recognize the extracted candidate idiomatic expression as an idiomatic expression.

Here, since the specific technology in the procedures is the same as the configuration of the idiomatic expression recognizing apparatus and method using the phrase alignment of the bilingual parallel corpus, the description of the overlapping technology will be described.

While the exemplary embodiment of the present disclosure has been described using specific terms, such description is for illustrative purpose only, and it is to be understood that changes and variations may be made without departing from the spirit of scope of the following claims. The scope of the disclosure is to be interpreted by the following claims and all technologies within the equational range are to be interpreted to be covered by the scope of the disclosure.

### INDUSTRIAL APPLICABILITY

The present disclosure extracts a candidate idiomatic expression using phrase alignment information of a bilingual parallel corpus, measures an idiomatic expression index for every extracted candidate idiomatic expression to recognize as an idiomatic expression, thereby resolving errors in measuring a translational entropy of a word and extracting a representative translated word of the word and improving the accuracy of the idiomatic expression recognition.

1. An idiomatic expression recognizing apparatus using phrase alignment of a bilingual parallel corpus, comprising:
a bilingual parallel corpus input unit configured to receive a bilingual parallel corpus;
a phrase aligning unit configured to perform phrase alignment for every sentence pair of the input bilingual parallel corpus;
a candidate expression extracting unit configured to extract a candidate idiomatic expression using the performed phrase alignment result; and
an idiomatic expression recognizing unit configured to measure an idiomatic expression index for every extracted candidate idiomatic expression and compare the measured idiomatic expression index with a predetermined threshold to recognize the extracted candidate idiomatic expression as an idiomatic expression.

2. The idiomatic expression recognizing apparatus using phrase alignment of a bilingual parallel corpus of claim 1, wherein the phrase aligning unit connects a source phrase with a target phrase in the bilingual parallel sentence pair of the input bilingual parallel corpus to perform the phrase alignment.

3. The idiomatic expression recognizing apparatus using phrase alignment of a bilingual parallel corpus of claim 1, wherein the phrase aligning unit performs the phrase alignment including word alignments of word to word, one word to several words, and several words to several words for every sentence pair of the input bilingual parallel corpus.

4. The idiomatic expression recognizing apparatus using phrase alignment of a bilingual parallel corpus of claim 1, wherein the candidate expression extracting unit extracts the candidate idiomatic expression from the phrase pairs in which the phrases are aligned using a source portion phrase as one basic unit.

5. The idiomatic expression recognizing apparatus using phrase alignment of a bilingual parallel corpus of claim 1, wherein the candidate expression extracting unit removes a phrase including at least one of a period, a comma, quotation marks, and parentheses or removes a phrase having only one word excepting articles and prepositions from the extracted candidate idiomatic expression.

6. The idiomatic expression recognizing apparatus using phrase alignment of a bilingual parallel corpus of claim 1, wherein the idiomatic expression recognizing unit calculates an idiomatic expression index of the extracted candidate idiomatic expression using a translational entropy function to recognize an idiomatic expression.

7. The idiomatic expression recognizing apparatus using phrase alignment of a bilingual parallel corpus of claim 1, wherein the idiomatic expression recognizing unit compares words in a default phrase translation obtained from the performed phrase alignment result with words in a default phrase translation of words in a phrase to calculate an overlapping percentage to recognize the idiomatic expression.

8. An idiomatic expression recognizing method using phrase alignment of a bilingual parallel corpus, comprising:
a bilingual parallel corpus input step of receiving a bilingual parallel corpus;
a phrase aligning step of performing phrase alignment for every sentence pair of the input bilingual parallel corpus;
a candidate expression extracting step of extracting a candidate idiomatic expression using the performed phrase alignment result; and
an idiomatic expression recognizing step of measuring an idiomatic expression index for every extracted candidate idiomatic expression and comparing the measured idiomatic expression index with a predetermined threshold to recognize the extracted candidate idiomatic expression as an idiomatic expression.

9. The idiomatic expression recognizing method using phrase alignment of a bilingual parallel corpus of claim 8, wherein the phrase aligning step connects a source phrase with a target phrase in the bilingual parallel sentence pair of the input bilingual parallel corpus to perform the phrase alignment.

10. The idiomatic expression recognizing method using phrase alignment of a bilingual parallel corpus of claim 8, wherein the phrase aligning step performs the phrase alignment including word alignments of word to word, one word to several words, and several words to several words for every sentence pair of the input bilingual parallel corpus.

11. The idiomatic expression recognizing method using phrase alignment of a bilingual parallel corpus of claim 8, wherein the candidate expression extracting step extracts the candidate idiomatic expression from the phrase pairs in which the phrases are aligned using a source portion phrase as one basic unit.

12. The idiomatic expression recognizing method using phrase alignment of a bilingual parallel corpus of claim 8, wherein the candidate expression extracting step removes a phrase including at least one of a period, a comma, quotation marks, and parentheses or removes a phrase having only one word excepting articles and prepositions from the extracted candidate idiomatic expression.

13. The idiomatic expression recognizing method using phrase alignment of a bilingual parallel corpus of claim 8, wherein the idiomatic expression recognizing step calculates an idiomatic expression index of the extracted candidate idiomatic expression using a translational entropy function to recognize an idiomatic expression.

14. The idiomatic expression recognizing method using phrase alignment of a bilingual parallel corpus of claim 8, wherein the idiomatic expression recognizing step compares words in a default phrase translation obtained from the performed phrase alignment result with words in a default phrase translation of words in a phrase to calculate an overlapping percentage to recognize the idiomatic expression.

15. A computer readable recording medium in which a program for executing a step of claim 8 is recorded.
